(19) United States
(12) Patent Application Publication
(10) Pub. No.: US 2026/0321006 A1
(43) Pub. Date: Oct. 15, 2026

(54) SYSTEMS AND METHOD FOR VIDEO PROCESSING

(71) Applicant: TELEFONAKTIEBOLAGET LM ERICSSON (PUBL), Stockholm (SE)

(72) Inventors: Pex Tufvesson, Lund (SE); Tobias Widmark, Lund (SE)

(21) Appl. No.: 19/485,459

(22) PCT Filed: May 31, 2023
(86) PCT No.: PCT/IB2023/055599

§ 371 Date: Nov. 18, 2025

(51) Int. Cl. G06V 20/40; G11B 27/031

(52) U.S. Cl. CPC G06V 20/41; G11B 27/031

(57) ABSTRACT

A method performed by a computing apparatus for modifying a video. The method includes receiving a request to modify the video. The method also includes modifying the video based on the request to generate a modified video. Wherein modifying the video comprises removing one or more portions of the video from the video and/or adding content to the video. Removing one or more portions of the video from the video comprises: a) identifying a portion of the video having redundant content and removing from the video the identified redundant portion of the video, b) identifying a portion of the video having a low viewer retention and removing from the video the identified portion of the video having the low viewer retention, c) identifying a portion of the video having a low visual interest and removing from the video the identified portion of the video having the low visual interest, and/or d) identifying a portion of the video having a low emotional intensity and removing from the video the identified portion of the video having the low emotional intensity.

### TECHNICAL FIELD

Disclosed are embodiments related to systems and method for video processing.

### BACKGROUND

Many people have received a task to “watch a video of this recorded presentation, and let's discuss it later.” The video may be long or short, however, a person's time to watch it may be short or long. If the video is shorter than preferred, additional effort may be required to find more content on the topic. If the video is longer than preferred, the watcher may not have time to watch the entire video and, therefore, may miss important content that is introduced at the end of the video.

An entity named Wisecut provides online automatic video editing software. According to Wisecut's website, its software “can easily turn . . . long-form talking videos into short, impactful clips.” Wisecut's software identifies pauses in a video and deletes them automatically. On average, a 1-hour video can be condensed to 30 minutes by focusing on the most relevant content. Wisecut uses artificial intelligence and facial recognition to “punch in” and “punch out” of the video automatically. This widely used technique ensures that cuts, or jump cuts, have a more organic flow while using a single camera. U.S. Pat. No. 7,248,778 additionally describes an automated video editing system and method.

### SUMMARY

Certain challenges presently exist. For example, depending on one's knowledge of a field, one may wish for an extended version of a video or a shortened summary of the video. In addition, the viewer may only have 20 minutes to watch an hour video, or the video is only 5 minutes and the viewer would like to know more about the topic. Conventional automated editing software haphazardly jumps through the video, resulting in a fragmented story with mindless jumps back and forth in the linear timeline of the recorded presentation. Therefore, a process for condensing or extending the runtime of a video while maintaining a level of quality is highly desirable.

Accordingly, in one aspect there is provided method performed by a computing apparatus for modifying a video. The method includes receiving a request to modify the video. The method also includes modifying the video based on the request to generate a modified video. Modifying the video comprises removing one or more portions of the video from the video and/or adding content to the video, and removing one or more portions of the video from the video comprises: a) identifying a portion of the video having redundant content and removing from the video the identified redundant portion of the video, b) identifying a portion of the video having a low viewer retention and removing from the video the identified portion of the video having the low viewer retention, c) identifying a portion of the video having a low visual interest and removing from the video the identified portion of the video having the low visual interest, and/or d) identifying a portion of the video having a low emotional intensity and removing from the video the identified portion of the video having the low emotional intensity.

In another aspect there is provided a computer program comprising instructions which when executed by processing circuitry of a computing apparatus causes the computing apparatus to perform any of the methods disclosed herein. In one embodiment, there is provided a carrier containing the computer program wherein the carrier is one of an electronic signal, an optical signal, a radio signal, and a computer readable storage medium. In another aspect there is provided a computing apparatus that is configured to perform the methods disclosed herein. The computing apparatus may include memory and processing circuitry coupled to the memory.

An advantage of the embodiments disclosed herein is that they increase the quality of a video by intelligently modifying the video. For example, a video is edited to fit a viewer's current time budget while maintaining a level of quality and engagement.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates removing silences according to an embodiment.

FIG. 3 illustrates removing redundant content according to an embodiment.

FIG. 4 illustrates removing portions of a video having low viewer retention according to an embodiment.

FIG. 5 illustrates removing portions of a video having low visual interest according to an embodiment.

FIG. 6 illustrates removing portions of a video having low emotional intensity according to an embodiment.

FIG. 7 illustrates a process for extending a video according to an embodiment.

FIG. 8 is a flowchart illustrating a process according to an embodiment.

FIG. 9 is a flowchart illustrating a process according to an embodiment.

FIG. 10 is a block diagram of a video editing system according to an embodiment.

### DETAILED DESCRIPTION

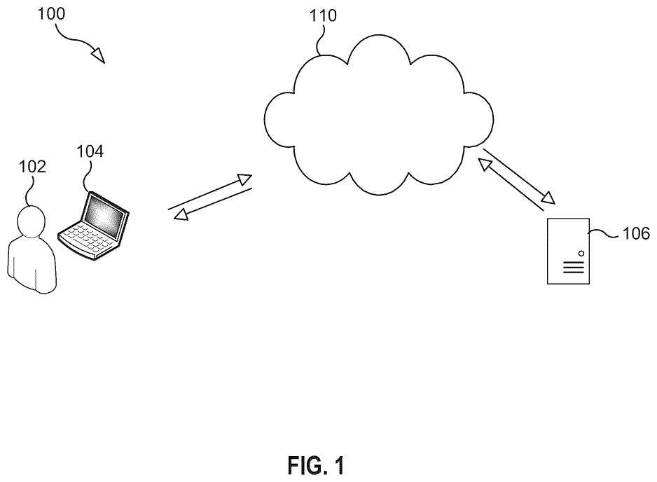

FIG. 1 illustrates a video processing system 100, according to an embodiment, for processing videos for a user 102. In the embodiment shown, video processing system 100 includes a user terminal (UT) 104, which may include a video player, in communication (e.g., wired and/or wireless communication) with a video editing system (VES) 106 via a network 110 (e.g., the internet). VES 106 may be a component of a cloud service. As used herein, a UT is any device capable of communicating with VES 106 via network 110. Accordingly, UT 104 may be a smartphone, a personal computer, a tablet, a phablet, a laptop computer, etc. In another embodiment, VES 106 is a component of UT 104. For the sake of brevity, the embodiments will be described in the context where VES 106 is remote from UT 104.

User 102 may select a video, such as a conference presentation, to watch on their UT 104. Due to time considerations and/or an interest level, however, user 102 may wish to condense or extend the runtime of the video. For example, user 102 may only have 20 minutes to watch an hour long video in preparation for a meeting later that day. In another example, user 102 may enjoy a 20 minute video, but wish the video was longer. User 102 may transmit the video, along with a request to condense or extend the runtime of the video, to VES 106 via network 110.

VES 106 is capable of receiving a video selected by the user, analyzing the video, and editing the video such that the length of the video is either reduced or extended (it is also possible that after editing the length is not changed because content has been both removed and added to the video). In some embodiments, VES 106 may analyze and edit the video using machine learning. VES 106 may edit the video by changing its contents such that the edited video presents relevant information to the user in an engaging manner. User 102 may specify different types of editing and analysis in which they are interested, with VES 106 changing the final rendition of the video to suit the user's request. Videos selected by user 102 may include presentations, documentaries, educational videos, recreational videos, and any other type of video recording.

In some embodiments, VES 106 may extend the contents and runtime of the video by looking up facts and inserting textual segments into the video. The additional materials included in the extended video may be from related videos and links with additional content.

In some embodiments, VES 106 may perform light condensing by cutting pauses such that there is little to no wait time between utterances (e.g., cutting all or some breathing pauses of a speaker) and/or with time-stretch that increases audio/video speed while maintaining voice pitch. VES 106 may also perform greater condensing by utilizing sound to text, with an analysis of the facts and contents presented in the video. The parts of the video with repeated content or slow progress may be cut away to remove redundancies. The visual contents of the video may be analyzed to ensure the visually interesting parts of the video are preserved while the static parts are removed. Also, VES 106 may analyze the audio track of the video for emotions and feelings, to keep the emotionally intense parts. Additionally, a histogram of where other viewers spent the most time watching may be used to identify important parts of the video. VES 106 may also perform extreme condensing by presenting a synopsis of the video with the most important facts and events.

VES 106 may use several processes to condense a runtime of a video, including: a) removing silent portions of the video; b) removing redundant portions of the video; c) removing portions of the video having low viewer retention; d) removing portions of the video having low visual interest; and/or e) removing portions of the video having low emotional intensity.

In some embodiments, the processes can be combined, either by the user, or from VES 106 performing an analysis of the video's contents to determine which one(s) are the most suitable to reduce video length while maintaining engagement.

In some embodiments, the processes for condensing the runtime of the video and extending the runtime of the video may be used together to help avoid abrupt cuts and create an edited video with a consistent flow. For example, small additions to the script and voice synthesizing may be used to transition from one video section to another.

In some embodiments, several of the processes to condense a runtime of a video may be combined and weighed to determine if a section of a video should be removed or not. For example, a section that has no relevant audio/silence could still be included if it has high visual interest, and similarly a section with low emotional intensity could be kept if it has high viewer retention.

In some embodiments, VES 106 analyzes the original video to determine the aesthetics of the video, graphical elements, sound & music genres, tone, and pacing, etc. The aesthetic analysis may then influence the choices of VES 106 when generating the edited video, to ensure that added/changed content still fits in with the original video's aesthetic.

In some embodiments, VES 106 provides A/B testing to determine how satisfactory the final video is when presented to the user. Variations in how the processes are performed are introduced, and feedback is gathered from the user in how they feel the service performed. This feedback can also be attained by detecting whether the user jumps between or skips part of the video.

### Removing “Silent” Portions of the Video

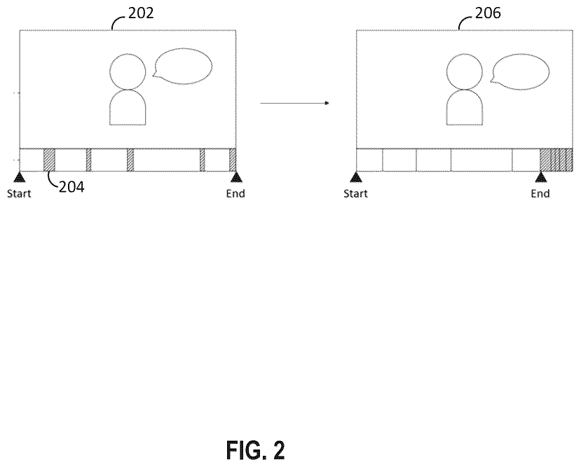

FIG. 2 illustrates an initial video 202 that is processed by VES 106 to produce an edited video 206. In this example, VES 106 produces the edited video by, at the least, removing “silences” from video 202. That is, VES 106 may receive a request from user 102 to condense the runtime of initial video 202 and to reduce the runtime VES 106 may detect portions 204 of the initial video 202 which contain “silences.” The detected silent portions 204 of video 202 are removed from video 202, thereby producing edited video 206, which is shorter than initial video 202 and potentially better paced than initial video 202.

In some embodiments, a “silent” portion of the video is a portion of the video in which the audio track contains no sound (i.e., the portion of the video is truly silent) or contains “filler” sound (e.g., background music or background noise) that does not add to the contents of the video (i.e., sound that does not provide any useful information to the viewer). VES 106 may determine that a portion of the video consists of filler sound by: 1) detecting that the audio track for the portion of the video consists of background music 2) determining a genre of the detected background music, 3) determining a topic of a section the video in which the portion is located, and 4) determining that the genre is not associated with the topic. VES 106 may detect background music by determining that the music does not have any lyrics. Filler sound may also be detected by determining a description of a visual aspect of the video, determining a genre and/or lyrics of music included in the audio track, and determining the genre and/or lyrics of the music is not associated with the description of the visual aspect.

In some embodiments, the analysis by VES 106 may consider if any portions of the video may benefit from some amount of silence to help with the video's flow and/or preserve user engagement. Accordingly, such silent portions may be retained rather than removed.

### Removing Redundant Portions of the Video

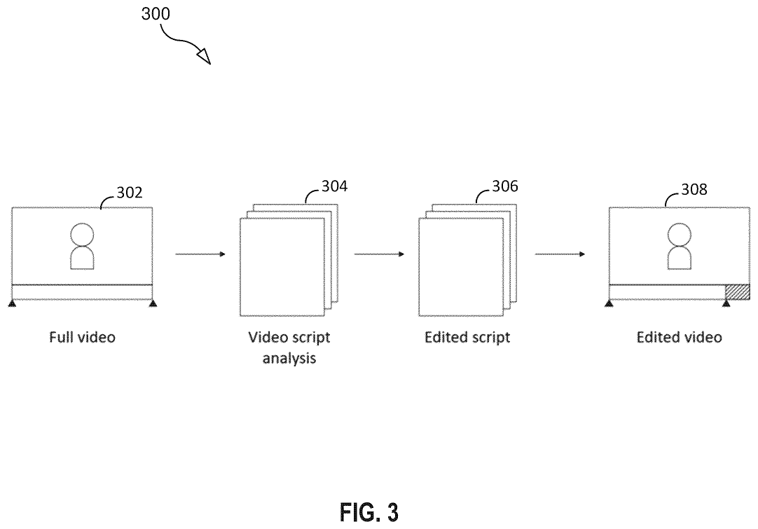

FIG. 3 illustrates a process 300 for removing redundant portions from an initial video 302 to produce an edited video 308. To determine wither a portion of video 302 is redundant, VES 106 obtains a script of video 302. In some embodiments, VES 106 obtains the script using a speech-to-text algorithm or may receive a separate script text file. The speech-to-text algorithm may be a free and open source algorithm such as OpenAI's Whisper speech-to-text.

In one embodiment, using the obtained script, VES 106 divides the video into portions and performs a script analysis 304 to determine a topic (e.g., a key point) for each portion of the video. VES 106 may use a text analysis software to determine the topics. The text analysis software may be embodied as a large language model, such as GPT-4, LLaMA, OpenLLaMA and StableLM. The text analysis software may use word embeddings to determine a topic of each portion of the video.

Then using the topics, VES 106 determines the portions of the video which contain redundant material. The redundant material may include filler words included in a filler word list or which are unrelated to the topic. An edited script 306 is produced by removing the redundant material from the script. VES 106 may then generate the edited video 308 without the portions of the video which contain redundant material.

### Removing Portions of the Video Having Low Viewer Retention

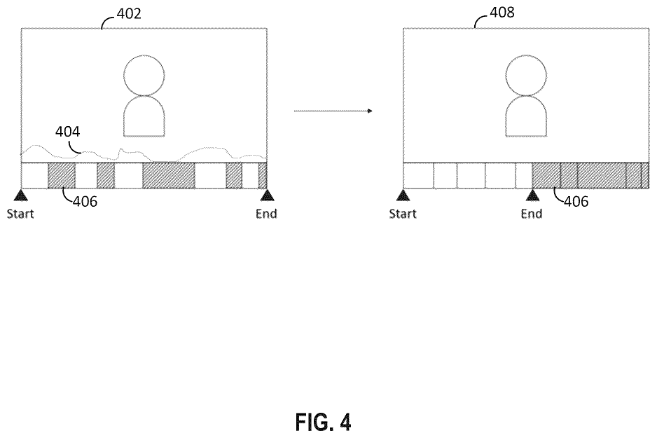

FIG. 4 illustrates an initial video 402 that is processed by VES 106 to produce an edited video 406. In this example, VES 106 produces the edited video by, at the least, removing from video 402 portions 406 of video 402 having low viewer retention. VES 106 may identify these low viewer retention portions 406 by: 1) dividing video 402 into a plurality of portions; 2) for each portion, obtaining aggregate viewer data 404 for the portion (e.g., viewer data for a multitude of users); 3) using the viewer data to calculate a viewer retention score for the portion; and 4) comparing the viewer retention score to a viewer retention threshold. In one embodiment, the portions of video 402 having a viewer retention score lower than the threshold are removed from video 402, thereby producing the edited video 408 that does not contain the removed portions, but contains other portions of video 402 that have not been removed.

In one embodiment, VES 106 calculates, from the aggregate viewer data, the viewer retention score for a video portion by determining the percentage of users who skipped the video portion (e.g., stopped watching the video during the video portion or skipped over the video portion to watch another portion) and setting the viewer retention score equal to this determined percentage. In another embodiment, VES 106 calculates, from the aggregate viewer data, the viewer retention score for a video portion by: 1) determining i) the percentage of users who skipped the video portion and ii) the percentage of user who watched the video portion more than once and 2) setting the viewer retention score equal to the average (or weighted average) of these two determined percentages.

In some embodiments, a video player, such as UT 104, may register a user's emotions and/or engagement while the user is viewing a video. For example, by tracking the viewer's eye movement, the video player can determine whether a viewer has stopped watching the video. The video player may register which portions of the video the user re-watched or skipped. VES 106 may use this data to determine the viewer retention score for different portions of the video. In such embodiments, a viewer may choose to opt-in to and/or opt-out of this feature.

### Removing Portions of the Video Having Low Visual Interest

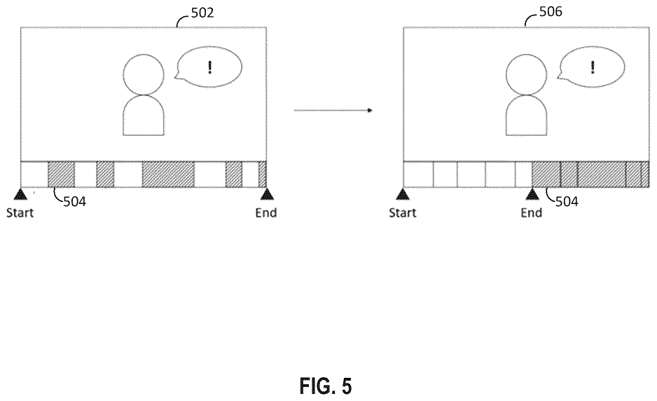

FIG. 5 illustrates an initial video 502 that is processed by VES 106 to produce an edited video 506. In this example, VES 106 produces the edited video by, at the least, removing from video 502 portions 504 of video 502 having low visual interest. VES 106 may identify these low visual interest portions 504 by: 1) dividing video 502 into a plurality of portions; 2) for each portion, determining a level of visual interest for the portion (e.g., a level of visual interest score indicating the level of visual interest); and 3) determining the portions 504 of the video for which the level of visual interest score is below a visual interest threshold. The portions 504 having low visual interest are removed from video 502, thereby producing the edited video 506 that does not contain the removed portions, but contains other portions of video 502 that have not been removed.

In some embodiments, portions of the video having little visual change between frames, no change at all between frames, having still images, or uninteresting background footage may be identified as having low visual interest. Visual interest may be determined using color histogram analysis or using object and context analysis to determine the complexity of a visual element. The complexity of a visual element may be associated with importance and view-time needed. Color histogram analysis and/or object and context analysis may be combined with script analysis to determine if a visual element is relevant to the topic of the video. For example, a car on a road could be of interest in one type of video, but visual filler in another.

### Removing Portions of the Video Having Low Emotional Intensity

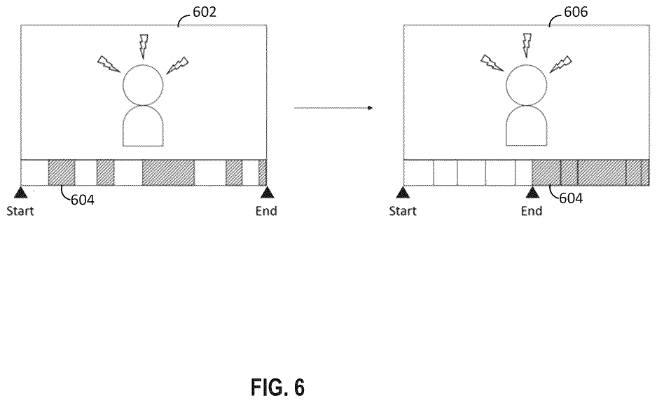

FIG. 6 illustrates an initial video 602 that is processed by VES 106 to produce an edited video 606. In this example, VES 106 produces the edited video by, at the least, removing from video 602 portions 604 of video 602 having a low emotional intensity. VES 106 may identify these low emotional intensity portions 604 by: 1) dividing video 602 into a plurality of portions; 2) for each portion, determining an emotional intensity score; and 3) determining the portions 604 of the video for which the emotional intensity score is below a threshold. In one embodiment, the portions 604 having an emotional intensity score below the threshold are removed from video 602, thereby producing the edited video 606 that does not contain the removed portions, but contains other portions of video 602 that have not been removed.

In one embodiment, VES 106 determines the emotional intensity score for a video portion based on: i) an audio analysis of the video portion to determine the emotional intensity of the audio (e.g., a voice analysis to determine the speaker's emotional state or a music analysis to determine the emotional intensity of the music playing, if any), ii) image analysis of the video portion to determine if the contents of the video are likely to cause strong emotions in the viewer, iii) a topic of the video portion, and/or iv) a context analysis of the audio and/or visual component of the video portion. The topic and/or context of the portion may impact its emotional level.

In some embodiments, in addition to removing video portions having a low emotional intensity, video portions are removed based on the user's preferences. A user may set their viewing preferences to “keep the facts only,” “emphasize emotional content,” “give me the happy parts,” “remove sad parts,” “focus on the human factors,” “I'd love to see cars,” “bring me the angry content,” and so forth. VES 106 will consider the viewing preferences when determining which video portions to remove. For example, a video portion that evokes sadness may have a high emotional intensity score, but because the user do not want to see such content, the video portion is removed. Similarly, in some embodiments, video portions having an emotional intensity score below the threshold may nonetheless be kept in the edited video 606, such as, for example, when the video portion would help keep viewer engagement high.

### Extending the Runtime of the Video

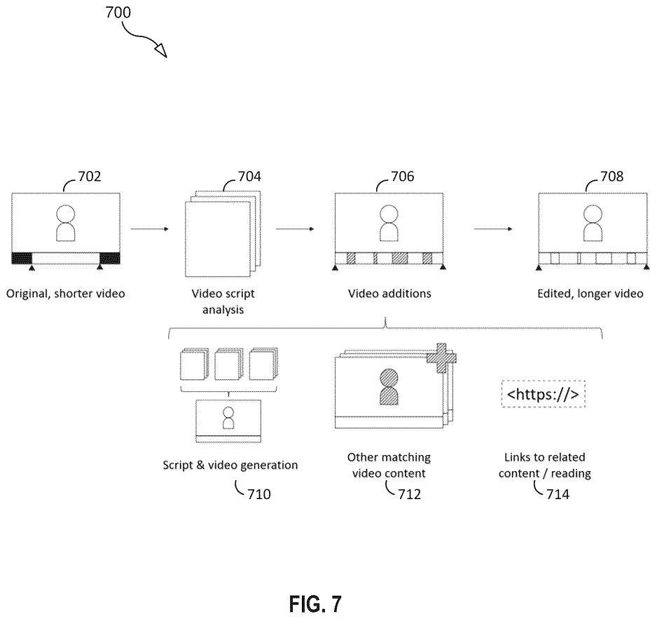

FIG. 7 illustrates a process 700, according to an embodiment, that is performed by VES 106 in response to receiving a request for adding content to a video 702. In one embodiment, to add content to the video, VES 106 obtains a script of video 702 and uses the script to identify a topic (e.g., a key point) of the video (this identification can be done by performing an analysis using a conventional topic analysis model). In some embodiments, the script is obtained by generating the script using a conventional speech-to-text system. In another embodiment, the script is submitted along with video 702.

After identifying a topic, VES 106 may then, based on the identified topic, obtain additional material 706 related to the identified topic to add to video 702, thereby generating an edited video 708. The additional material may be obtained from a known database to which VES 106 has a license. The license allows VES 106 to embed into other videos content obtained from the database. In one embodiment, prior to adding to video 702 additional material related to a particular identified topic, VES 106 determines an appropriate point within video 702 at which the additional material is to be inserted. An appropriate point for inserting additional material related to a particular topic may be a point in video 702 at which video 702 changes from focusing on the particular topic to focusing on another topic.

In some embodiments, script additions 710 may be created and appropriate video footage is selected, such as applicable stock footage or sections from the original video 702. Script additions 710 may be added to video 702 using a voice synthesizer, either using a pre-existing voice setting or generating a new voice setting matching the speaker in original video 702. In some embodiments, if there is other matching video content 712 found, such as previously generated material or sections from other videos, that video content can be added as well. Non-video content can be added to video 702 as links 714 in the video, as suggested further reading. The additions are placed in original video 702 at appropriate times (e.g., the end of a section/sentence), creating an edited version 708 of the original video 702, which will be longer than video 702 assuming that video portions have not been removed from video 702, for example, as described above.

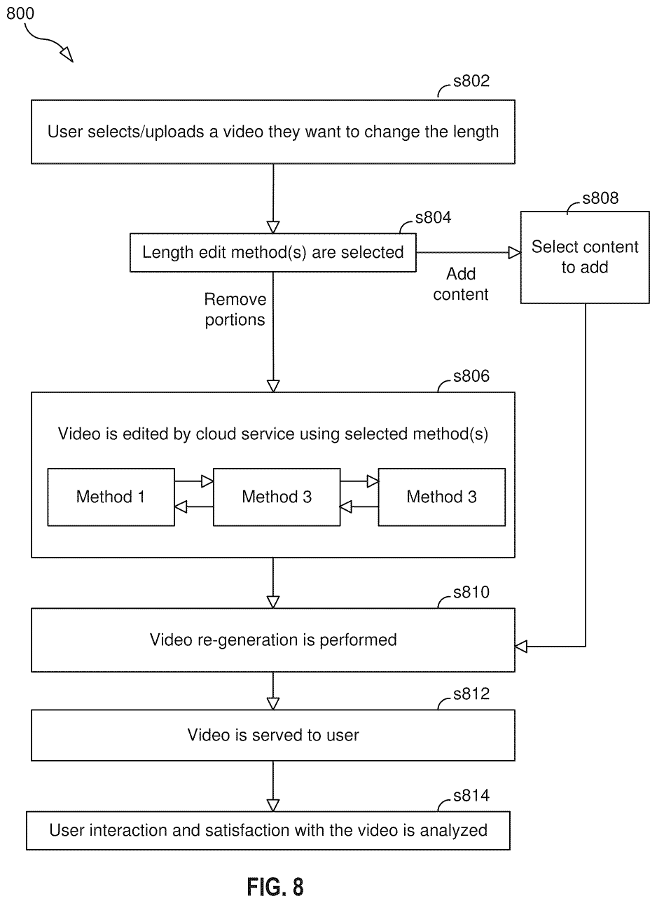

FIG. 8 is a flowchart illustrating a process 800, according to an embodiment. Process 800 may begin with step s802. Step s802 comprises the user selecting a video to be edited by VES 106. This could be a video already available on a service platform, retrieved from a website, or a video that the user uploads themselves. Step s804 comprises the user deciding whether they want to remove video portions from the video as described above and/or add content to the video as described for example with respect to process 700. In some embodiments, the user may select the editing methods for the selected video and/or VES 106 may automatically select the editing methods. For example, the user may select editing options including desired length, music requirements, etc.

If video portions are to be removed from the video, process 800 proceeds to step s806. Step s806 comprises VES 106 editing the video as requested using, for example, any of the video condensing features described herein. If multiple methods (e.g., methods 1, 2, and 3) are chosen by the user or VES 106, the editing methods may share data and knowledge between each other to create a coherent final video. Additionally, as noted above, several of the video reduction methods can be combined and weighed, to determine if a portion of a video should be removed or not. A portion that has no relevant audio/silence could still be included if it has high visual interest, and similarly a section with low emotional intensity could be kept if it has high viewer retention, as two examples.

If content is to be added to the video, process 800 proceeds to step s808. Step s808 comprises VES 106 obtaining content to add to the video (e.g., VES 106 may perform process 700).

Step s810 comprises re-generating the video to create proper transitions between edited parts, to avoid abrupt cuts or otherwise moments in the video edit deemed unsatisfactory. This could be through small additions to the script and voice synthesizing to go from one video section to another, as an example

Step s812 comprises providing the edited video to the user. The user may resubmit the video if they are unsatisfied or adjust settings of the editing methods.

Step s814 comprises VES 106 receiving feedback from the user to determine a level of satisfaction with the edited video. The feedback may be used to improve the editing methods and achieve better results in future iterations of the service. Feedback can be gathered from the user manually or through other methods, such as detecting if the user skips parts of the finished video.

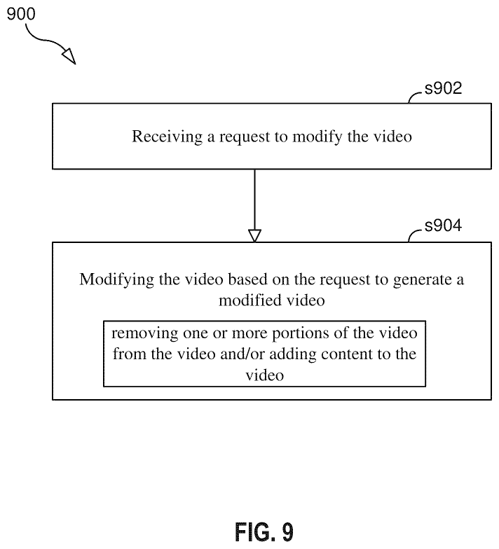

FIG. 9 is a flowchart illustrating a process 900, according to an embodiment, for modifying a video. In some embodiments, the process 900 may be performed by a computing apparatus (e.g., VES 106). Process 900 may begin in step s902. Step s902 comprises receiving a request to modify the video. Step s 904 comprises modifying the video based on the request to generate a modified video. Modifying the video comprises removing one or more portions of the video from the video and/or adding content to the video, and removing one or more portions of the video from the video comprises: a) identifying a portion of the video having redundant content and removing from the video the identified redundant portion of the video, b) identifying a portion of the video having a low viewer retention and removing from the video the identified portion of the video having the low viewer retention, c) identifying a portion of the video having a low visual interest and removing from the video the identified portion of the video having the low visual interest, and/or d) identifying a portion of the video having a low emotional intensity and removing from the video the identified portion of the video having the low emotional intensity.

In some embodiments, modifying the video comprises removing one or more portions of the video from the video, and removing one or more portions of the video from the video comprises identifying a silent portion of the video and removing from the video the identified silent portion of the video.

In some embodiments, wherein identifying a silent portion of the video comprises detecting a portion of the video where an audio track for the portion of the video contains no sound or contains filler sound (e.g., background music).

In some embodiments, identifying a silent portion of the video comprises detecting a portion of the video where the audio track for the portion of the video contains filler sound, and detecting a portion of the video where the audio track for the portion of the video contains filler sound comprises: determining that the audio track for the portion of the video contains music; determining a genre of the music; determining a topic of the portion of the video; and determining that the genre is not associated with the topic.

In some embodiments, identifying a silent portion of the video comprises detecting a portion of the video where the audio track for the portion of the video contains filler sound, and detecting a portion of the video where the audio track for the portion of the video contains filler sound comprises determining that the audio track for the portion of the video contains music without any lyrics.

In some embodiments, modifying the video comprises removing one or more portions of the video from the video, removing one or more portions of the video from the video comprises removing the identified redundant portion of the video, and identifying the redundant portion of the video comprises: obtaining a script of the video, the video having a plurality of portions; using the script, determining a topic for each portion of the plurality of portions; and using the determined topics, determining that a portion of the plurality of portions contains redundant material.

In some embodiments, wherein determining a topic for each portion of the plurality of portions comprises using a large language model.

In some embodiments, wherein determining that a portion of the plurality of portions contains redundant material comprises: determining that the portion of the plurality of portions contains a filler word, wherein the filler word is included in a filler word list and/or is unrelated to the topics.

In some embodiments, modifying the video comprises removing one or more portions of the video from the video, removing one or more portions of the video from the video comprises removing from the video the identified portion of the video having the low viewer retention; and identifying the portion of the video having the low viewer retention comprises: obtaining viewer data, wherein the viewer data indicates a level of viewer retention for a portion of the video; and determining that the level of viewer retention for the portion of the video is below a viewer retention threshold.

In some embodiments, modifying the video comprises removing one or more portions of the video from the video, removing one or more portions of the video from the video comprises removing from the video the identified portion of the video having the low visual interest; and identifying the portion of the video having a low visual interest comprises: determining a level of visual interest for a portion of the video; and determining that the level of visual interest for the portion of the video is below a visual interest level threshold.

In some embodiments, determining the level of visual interest for the portion of the video comprises: determining a level of visual change between frames of the portion of the video; determining a level of complexity of an image in the portion of the video; and/or determining whether a visual element of the portion of the video is relevant to a topic of the portion of the video.

In some embodiments, the method comprises removing one or more portions of the video from the video, removing one or more portions of the video from the video comprises removing from the video the identified portion of the video having the low emotional intensity, and identifying the portion of the video having a low emotional intensity comprises: determining a level of emotion of a speaker in a portion of the video and/or a level of viewer emotion induced when viewing the portion of the video; and comparing the level of emotion and/or the level of viewer emotion to an emotion threshold.

In some embodiments, determining the level of emotion of the speaker in the portion of the video and/or the level of viewer emotion induced when viewing the portion of the video comprises: determining a topic of the portion of the video; performing a context analysis of an audio and/or visual portion of the portion of the video; and determining the level of emotion of the speaker in the portion of the video and/or the level of viewer emotion induced when viewing the portion of the video using the topic and/or context analysis.

In some embodiments, modifying the video comprises adding content to the video, adding content to the video comprises: obtaining a script of the video; using the script, identifying a topic of the video; obtaining additional material associated with the topic; and inserting the additional material into the video.

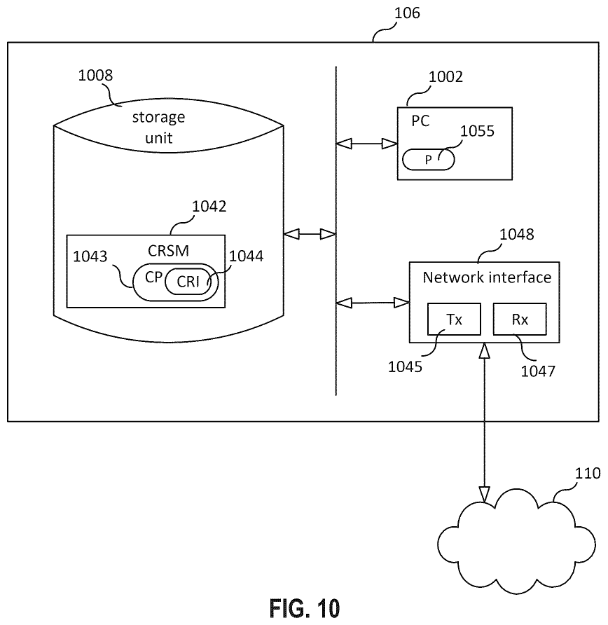

FIG. 10 is a block diagram of VES 106 according to some embodiments. As shown in FIG. 10, VES 106 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., VES 106 may be a monolithic computing apparatus or a distributed computing apparatus); at least one network interface 1048 (e.g., a physical interface or air interface) comprising a transmitter (Tx) 1045 and a receiver (Rx) 1047 for enabling VES 106 to transmit data to and receive data from other nodes connected to network 110 (e.g., an Internet Protocol (IP) network) to which network interface 1048 is connected (physically or wirelessly) (e.g., network interface 1048 may be coupled to an antenna arrangement comprising one or more antennas for enabling VES 106 to wirelessly transmit/receive data); and a storage unit (a.k.a., “data storage system”) 1008, which may include one or more non-volatile storage devices and/or one or more volatile storage devices. In embodiments where PC 1002 includes a programmable processor, a computer readable storage medium (CRSM) 1042 may be provided. CRSM 1042 may store a computer program (CP) 1043 comprising computer readable instructions (CRI) 1044. CRSM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes VES 106 to perform the steps described herein (e.g., steps described herein with reference to the flow charts). In other embodiments, VES 106 may be configured to perform the steps described herein without the need for code. That is, for example, PC 1002 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other devices are used to relay the message from the source device to the intended recipient). Likewise, as used herein receiving a message “from” a sender encompasses receiving the message directly from the sender or indirectly from the sender (i.e., one or more devices are used to relay the message from the sender to the receiving device). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a computing apparatus for modifying a video, the method comprising:
receiving a request to modify the video; and
modifying the video based on the request to generate a modified video, wherein
modifying the video comprises removing one or more portions of the video from the video and/or adding content to the video, and
removing one or more portions of the video from the video comprises:
a) identifying a portion of the video having redundant content and removing from the video the identified redundant portion of the video,
b) identifying a portion of the video having a low viewer retention and removing from the video the identified portion of the video having the low viewer retention,
c) identifying a portion of the video having a low visual interest and removing from the video the identified portion of the video having the low visual interest, and/or
d) identifying a portion of the video having a low emotional intensity and removing from the video the identified portion of the video having the low emotional intensity.

2. The method of claim 1, wherein
modifying the video comprises removing one or more portions of the video from the video, and
removing one or more portions of the video from the video comprises identifying a silent portion of the video and removing from the video the identified silent portion of the video.

3. (canceled)

4. The method of claim 2, wherein
identifying the silent portion of the video comprises detecting a portion of the video where the audio track for the portion of the video contains filler sound, and
detecting a portion of the video where the audio track for the portion of the video contains filler sound comprises:
determining that the audio track for the portion of the video contains music;
determining a genre of the music;
determining a topic of the portion of the video; and
determining that the genre is not associated with the topic.

5. The method of claim 2, wherein
identifying the silent portion of the video comprises detecting a portion of the video where the audio track for the portion of the video contains filler sound, and
detecting a portion of the video where the audio track for the portion of the video contains filler sound comprises determining that the audio track for the portion of the video contains music without any lyrics.

6. The method of claim 1, wherein
modifying the video comprises removing one or more portions of the video from the video,
removing one or more portions of the video from the video comprises removing the identified redundant portion of the video, and
identifying the redundant portion of the video comprises:
obtaining a script of the video, the video having a plurality of portions;
using the script, determining a topic for each portion of the plurality of portions; and
using the determined topics, determining that a portion of the plurality of portions contains redundant material.

7. (canceled)

8. The method of claim 6, wherein determining that a portion of the plurality of portions contains redundant material comprises:
determining that the portion of the plurality of portions contains a filler word, wherein the filler word is included in a filler word list and/or is unrelated to the topics.

9. The method of claim 1, wherein
modifying the video comprises removing one or more portions of the video from the video,
removing one or more portions of the video from the video comprises removing from the video the identified portion of the video having the low viewer retention; and
identifying the portion of the video having the low viewer retention comprises:
obtaining viewer data, wherein the viewer data indicates a level of viewer retention for a portion of the video; and
determining that the level of viewer retention for the portion of the video is below a viewer retention threshold.

10. The method of claim 1, wherein
modifying the video comprises removing one or more portions of the video from the video,
removing one or more portions of the video from the video comprises removing from the video the identified portion of the video having the low visual interest; and
identifying the portion of the video having a low visual interest comprises:
determining a level of visual interest for a portion of the video; and
determining that the level of visual interest for the portion of the video is below a visual interest level threshold.

11. The method of claim 10, wherein determining the level of visual interest for the portion of the video comprises:
determining a level of visual change between frames of the portion of the video;
determining a level of complexity of an image in the portion of the video; and/or
determining whether a visual element of the portion of the video is relevant to a topic of the portion of the video.

12. The method of claim 1, wherein
the method comprises removing one or more portions of the video from the video,
removing one or more portions of the video from the video comprises removing from the video the identified portion of the video having the low emotional intensity, and
identifying the portion of the video having a low emotional intensity comprises:
determining a level of emotion of a speaker in a portion of the video and/or a level of viewer emotion induced when viewing the portion of the video; and
comparing the level of emotion and/or the level of viewer emotion to an emotion threshold.

13. The method of claim 12, wherein determining the level of emotion of the speaker in the portion of the video and/or the level of viewer emotion induced when viewing the portion of the video comprises:
determining a topic of the portion of the video;
performing a context analysis of an audio and/or visual portion of the portion of the video; and
determining the level of emotion of the speaker in the portion of the video and/or the level of viewer emotion induced when viewing the portion of the video using the topic and/or context analysis.

14. The method of claim 12, wherein
modifying the video comprises adding content to the video,
adding content to the video comprises:
obtaining a script of the video;
using the script, identifying a topic of the video;
obtaining additional material associated with the topic; and
inserting the additional material into the video.

15.-16. (canceled)

17. A computing apparatus for modifying a video, the computing apparatus comprising processing circuitry configured to:
receive a request to modify the video; and
modify the video based on the request to generate a modified video, wherein the processing circuitry configured to modify the video is further configured to:
remove one or more portions of the video from the video and/or adding content to the video, and
remove one or more portions of the video from the video, wherein the processing circuitry configured to remove one or more portions of the video is further configured to:
a) identify a portion of the video having redundant content and removing from the video the identified redundant portion of the video,
b) identify a portion of the video having a low viewer retention and removing from the video the identified portion of the video having the low viewer retention,
c) identify a portion of the video having a low visual interest and removing from the video the identified portion of the video having the low visual interest, and/or
d) identify a portion of the video having a low emotional intensity and removing from the video the identified portion of the video having the low emotional intensity.

18. (canceled)

19. The computing apparatus of claim 17 wherein the processing circuitry configured to modify the video is further configured to identify a silent portion of the video and remove from the video the identified portion of the video.

20. The computing apparatus of claim 17 wherein the processing circuitry configured to modify the video is further configured to identify a portion of the video that comprises filler sound and remove from the video the identified portion of the video.

21. The computing apparatus of claim 17 wherein the processing circuitry configured to modify the video is further configured to:
obtain a script of the video, the video having a plurality of portions;
determine a topic for each portion of the plurality of portions based on the script;
determine that a portion of the plurality of portions contains redundant material based on the topic for each portion of the video; and
remove the redundant portion of the video.

22. The computing apparatus of claim 17 wherein the processing circuitry configured to modify the video is further configured to:
obtain viewer data that indicates a level of viewer retention for one or more portions of the video;
remove one or more portions of the video having a level of viewer retention below a threshold.

23. The computing apparatus of claim 17 wherein the processing circuitry configured to modify the video is further configured to:
determine a level of visual interest for a portion of the video; and
determine that the level of visual interest for the portion of the video is below a visual interest level threshold; and
remove the portion of the video identified as having a level of interest below the visual interest level threshold.

24. The computing apparatus of claim 17 wherein the processing circuitry configured to modify the video is further configured to:
determine a level of emotion of a speaker in a portion of the video and/or a level of viewer emotion induced when viewing the portion of the video;
compare the level of emotion of the speaker and/or the level of viewer emotion to an emotion threshold; and
remove the portion of the video having an emotional intensity below the emotion threshold.

25. The computing apparatus of claim 17 wherein the processing circuitry configured to modify the video is further configured to:
obtain a script associated with the video;
identify a topic of the video based on the script;
obtain additional material associated with the topic; and
inserting the additional material into the video.
